(19) United States
(12) Patent Application Publication
(10) Pub. No.: US 2009/0294470 A1
(43) Pub. Date: Dec. 3, 2009

(54) Variable Frequency Drive for Gas Dispensing System

(75) Inventor: Steven W. Lampe, Westlake Village, CA (US)

Correspondence Address: BRACEWELL & GIULIANI LLP, P.O. BOX 61389, HOUSTON, TX, 77208-1389, US

(73) Assignee: NEOgas Inc., Spring, TX (US)

(21) Appl. No.: 12/472,999

(22) Filed: May 27, 2009

Related U.S. Application Data
(60) Provisional application No. 61/056,210, filed on May 27, 2008.

(51) Int. Cl. F17C 7/00; B67D 5/06; B67D 5/44; F17C 13/00

(52) U.S. Cl. 222/1; 222/3; 222/395; 222/396; 222/397

(57) ABSTRACT

A fixed and/or stationary modular unit consists of a hydraulic fluid tank, a variable frequency drive consisting of a variable frequency controller, a variable frequency motor, and a pressurization pump. A compressed gas transportation system consists of a cylinder or set of cylinders. Each cylinder has a charging port and a dispensing port. A pair of valves are located at each charging port of each cylinder, with one valve connected to an incoming hydraulic fluid line and the other valve connected to a hydraulic fluid return line. A valve is connected at the dispensing port of each cylinder. As gas is dispensed from cylinders, hydraulic fluid is pumped from the tank by the variable frequency drive into the cylinder at a rate substantially equal to the dispensing rate of the compressed gas to maintain a constant pressure within the cylinder.

This application claims priority to provisional application 61/056,210, filed May 27, 2008.

### FIELD OF THE INVENTION

This invention is a variable frequency drive for use with hydraulic pressurization equipment to control and regulate the flow of hydraulic fluid into a compressed gas cylinder, or a plurality of compressed gas cylinders, in order to maintain a constant cylinder pressure throughout the gas dispensing operation.

### BACKGROUND OF THE INVENTION

Compressed natural gas (CNG) is any natural gas that has been processed and treated for transportation, in bottles or cylinders, at ambient temperature and at a pressure approaching the minimum compressibility factor.

Natural gas is colorless, odorless, and lighter than air, and it easily dissipates into the atmosphere when it leaks. It burns with a flame that is almost invisible, and it has to be raised to a temperature above 620° C. in order to ignite. By way of comparison, it should be noted that alcohol ignites at 200° C. and gasoline at 300° C. For safety reasons, natural gas is odorized with sulfur for marketing purposes.

Natural gas is an alternative to oil and therefore, it has great strategic importance, since it is a fossil fuel found in porous subsurface rock. It usually has low levels of pollutants, similar to nitrogen, carbon dioxide, water and sulfur compounds that remain in a gaseous state at atmospheric pressure and ambient temperature. Compressed natural gas is stored at a pressure of 220 bars or 3190 psi and is transported in trailers of varying volumetric capacity, depending on legislation and customer/project requirements.

The principal advantage of using natural gas is the preservation of the environment. In addition to economic benefits, it is a non-polluting fuel and it burns cleanly, so its combustion products that are released into the atmosphere do not need to be treated.

The great need to transport and store natural gas has contributed to increasing gas research around the world. Traditionally, only a handful of methods of transporting and storing large quantities of gas have turned out to be feasible. The main problem in storing and transporting gas is the fact that it remains a gas far below ambient temperature and that a small quantity of gas occupies a large amount of space. The solution is to reduce the space gas occupies. Initially, the condensation of gas to a liquid was the mainly recommended logical solution. A typical natural gas (which is about 90% CH4) can be reduced to 1/600 of its gaseous volume when it is compressed into a liquid. Technically speaking, gaseous hydrocarbons in the liquid state are known as liquefied natural gas, which is more commonly known as LNG.

As indicated by the term, LNG involves liquefying natural gas and normally includes transporting and storing natural gas in a liquid state. Although liquefication would seem to be a solution as far as storage and transportation problems are concerned, there are certain disadvantages. First, in order to liquefy natural gas, it must be cooled to approximately −162° C. at atmospheric pressure before it liquefies. Second, LNG tends to warm up over long storage or holding periods, thus it does not remain at low temperature, which is required in order for it to remain in a liquid state. Cryogenic methods have been used to keep LNG well within the required temperature range while being transported, and the carrier system used to transport LNG must be fully cryogenic. Third, LNG must be regassified by distillation before it can be used. The cryogenic process requires a high initial cost to load and unload LNG. The container system and storage vessels require rare metals to keep the temperature at 160° C., so it cannot be justified as an economic alternative.

In order to solve the technical problems of ambient conditions of storage and transportation of LNG, as well as its temperature and high costs, a method of transporting compressed natural gas was developed. Natural gas is compressed or pressurized at high pressures. This is what is commonly called compressed natural gas or CNG.

Various methods have been proposed for storing and transporting compressed gases, such as natural gas, in pressurized vessels for overland transportation. The gas is typically stored and transported at high pressure and low temperature to maximize the amount of gas contained in each gas storage system. For example, compressed gas must be in a dense single-fluid state characterized as a very dense gas with no liquid.

CNG is typically transported over land in tanker trucks or tank wagons. Tankers have storage containers such as pressurized metal vessels. These storage vessels have high burst strengths and withstand the ambient temperature at which CNG is stored.

Before compressed natural gas is transported, the desired operation state is obtained first, normally by compressing the gas, which results in a high temperature and then cooling it to an ambient temperature. After the compressing and cooling process, CNG is loaded into the holding vessels of the storage system. The CNG is then shipped to its destination.

Upon arrival at destination, the CNG is unloaded, typically at a terminal with a number of high-pressure storage vessels or a feedline into a high-pressure turbine. If the terminal is at a pressure of 69 bar or 1000 psi for example, and the storage vessels are at 138 bar or 2000 psi, then a valve must be opened and the gas must be expanded at the terminal until the pressure in the vessels falls to a final pressure between 69 bar or 1000 psi and 138 bar or 2000 psi.

With conventional procedures, the CNG that has been shipped remains in the storage vessels (residual gas), which is then compressed in the terminal storage vessels by means of compressors. These compressors are expensive and increase the capital cost of the unloading process. Further, the temperature of the residual gas is raised by the heating effect of compression. The high temperature increases the required storage capacity, unless the temperature is lowered or excess gas is removed, thereby increasing onshore costs for transporting CNG. There would also be high energy consumption.

In the past, pumping systems have incorporated pumping hydraulic fluid in to a compressed gas cylinder in order to keep the pressure in the cylinder constant. In these pumping and dispensing systems, hydraulic fluid is pumped into the cylinder when a minimum pressure is reached within the cylinder. The hydraulic fluid stops being pumped into the cylinder when a desired maximum pressure is reached. This gas dispensing system requires a pump to continuously cycle on and off as the pressure minimums and maximums are reached during the dispensing process.

A new technique is necessary to reduce costs and the complexity of unloading CNG. The following technique may solve one or more of these problems. The present technique exceeds the deficiencies described by providing hydraulic pressurization equipment that is capable of servicing the motor vehicles efficiently while maintaining the same pressure at all times.

### SUMMARY OF THE INVENTION

A fixed and/or stationary modular unit consists of a hydraulic fluid tank, a variable frequency drive consisting of a variable frequency controller, a variable frequency motor, and a pressurization pump, and a compressed gas transportation system consisting of a cylinder or set of cylinders. Each cylinder has two ports, a hydraulic fluid charging port and a gas dispensing port, with actuated valves positioned at each port. A pair of valves are located at each charging port of each cylinder, with one valve connected to an incoming hydraulic fluid line and the other valve connected to a hydraulic fluid return line. A valve is connected at the dispensing port of each cylinder.

Gas is dispensed from the dispensing port of the cylinder by opening the valve at the dispensing port. A pressure sensor monitors the pressure of the cylinder and indicates when the pressure inside the cylinder has dropped. The valve connected to the incoming hydraulic fluid line is opened and hydraulic fluid is pumped from the tank by the variable frequency drive system into the cylinder at a rate substantially equal to the dispensing rate of the compressed gas to maintain a constant pressure within the cylinder. When the cylinder is exhausted, the valve at the gas dispensing port of the cylinder is closed. The valve connected to the incoming hydraulic fluid is also closed, and the valve connected to the hydraulic fluid return line is opened. Remaining gas in the cylinder expands and discharges the hydraulic fluid from the cylinder and into the return line, where it travels back into the hydraulic fluid tank.

### BRIEF DESCRIPTION OF THE DRAWINGS

FIG. 1(a) is a schematic of the hydraulic pressurization equipment (HPU) portion of the compressed gas filling system, including a variable frequency drive system, as comprised by the present technique.

FIG. 1(b) is a detailed schematic of the over-the-road compressed gas semi-trailer portion of the compressed gas filling system as comprised by the present technique.

FIG. 2 is schematic of the variable frequency drive system.

### DETAILED DESCRIPTION OF THE INVENTION

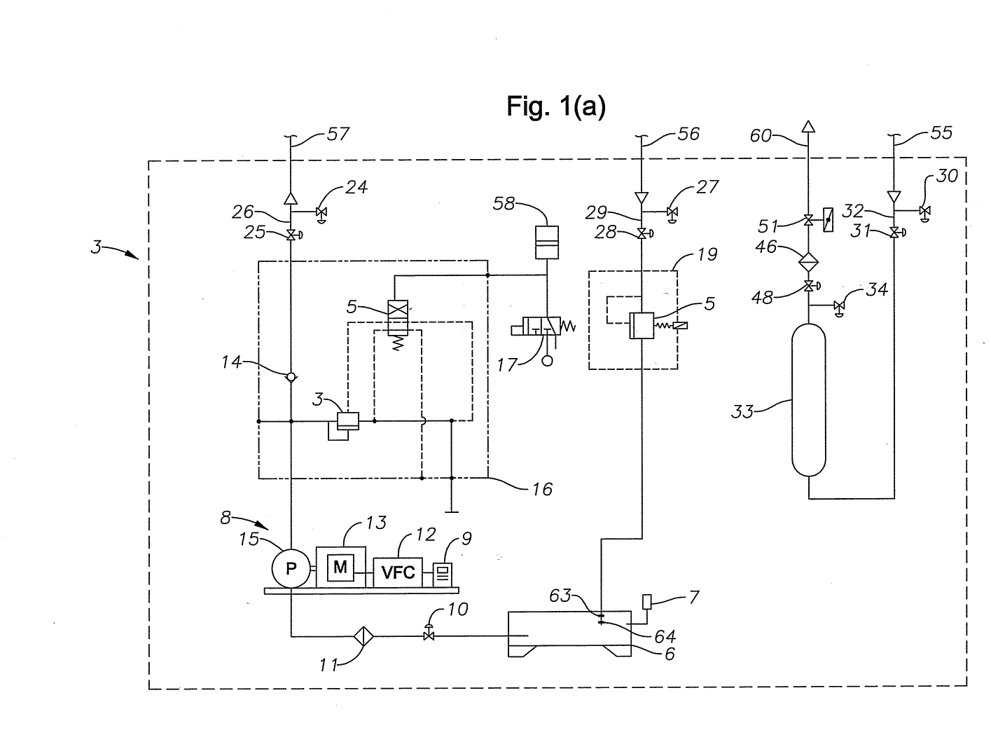

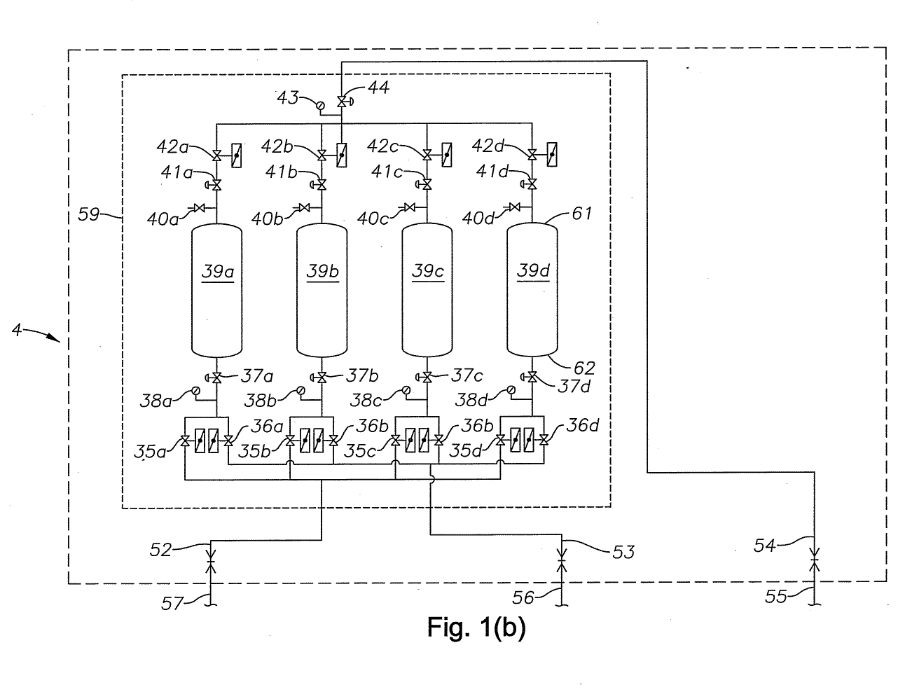

Referring to FIG. 1(a), the gas dispensing system consists of a hydraulic pressurization unit (HPU) 3 originally located at a dispensing station. An over-the-road compressed gas semi trailer 4 (FIG. 1(b)) is brought to the station and connected to the HPU 3. In an alternate embodiment, the HPU can be mounted on and a part of the over-the-road trailer 4 itself. The over-the-road semi trailer 4 may carry compressed natural gas, hydrogen, or other compressed gas cylinders.

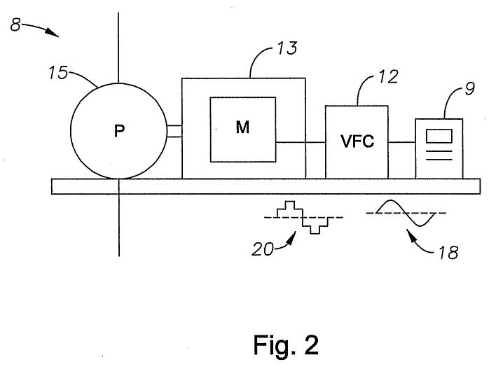

The HPU 3 consists of a hydraulic fluid tank 6 and a variable frequency drive system 8 (FIG. 2), which consists of a user interface 9, a variable frequency controller 12, a variable frequency AC motor 13, and a suction and pressurization pump 15. The HPU 3 also consists of an outgoing manifold block 16, a return manifold block 19, a pressure-control sensor 58, an electric/electronic control panel (not visible), and programmable logic controller (PLC) software. The outgoing manifold block 16 consists of valves 5, 17, pressure sensor 58, excess-flow valve 3, and a check valve 14. The return manifold block 19 consists of solenoid shutoff valve 5. The HPU 3 also consists of manual shutoff valves 10, 25, 28, 31, 48, particle filters 11, 46, and manual release valves 24, 27, 30, 34. Mounted to the oil reservoir tank 6 are photoelectric control sensors 63, 64, oil level switches 7, and a reservoir tank pressure switch (not visible). The HPU 3 is used to charge compressed natural gas (CNG), hydrogen, or other compressed gas cylinders to a specific pressure. The HPU 3 regulates the cylinder pressure by pumping hydraulic oil into the cylinders as gas is dispensed in order to maintain a substantially constant pressure in the cylinder while the gas is dispensed.

Referring to FIG. 1(b), the HPU 3 (FIG. 1(a)) is connected to over-the-road compressed gas semi trailer 4 comprised of gas cylinder module 59, of which each module may consist of a single cylinder or grouped sets of horizontal (tubular) cylinders. For example, in this embodiment, module 59 is comprised of cylinders 39a-d. Each cylinder has a charging port 62 and a dispensing port 61, which could be on opposite ends, as shown, or on the same end. A set of valves consisting of the following: safety devices 40a-d, manual shutoff valves 41a-d, 44, a pressure gauge 43, and actuated shutoff valves 42a-d, are connected at the dispensing port 61. The downstream connection from shutoff valve 44 is connected to a compressed gas loading/unloading line 54. A set of valves consisting of: pressure gauges 38a-d, manual shutoff valves 37a-d, and actuated shutoff valves 35a-d, 36a-d, are connected at the charging port 62.

The upstream connections from actuated shutoff valves 35a-d are connected to an incoming line 52, which has a quick connect/disconnect coupling mechanism positioned at its end. The downstream connections from actuated shutoff valves 36a-d are connected to oil return line 53, which has a quick connect/disconnect coupling mechanism positioned at its end. The upstream connections from the actuated shutoff valves 35a-d are connected parallel to one another. The downstream connections from actuated shutoff valves 42a-d are connected parallel to one another. The downstream connections from actuated shutoff valves 35a-d are connected with the charging port 62 of each of the cylinders 39a-d. The downstream connections from actuated shutoff valves 36a-d are connected parallel to one another. The upstream connections from actuated shutoff valves 42a-d are connected with the dispensing port 61 of each of the cylinders 39a-d.

Each module on the over-the-road compressed gas semi trailer is connected similarly. The cylinders on the over-the-road semi trailer are charged with compressed gas at another location. Subsequent to charging with compressed gas, the over-the-road semi trailer is transported to a gas filling station where an HPU is installed. In an alternate embodiment, the HPU 3 can be mounted on the over-the-road trailer. The over-the-road compressed gas semi trailer is connected to the HPU 3 with three hoses: an outgoing oil line 57, an oil return line 56, and a compressed gas line 55.

Referring to FIGS. 1(a) and 1(b), in order to dispense the compressed gas from the cylinder module, the start button on the control panel (not visible) is pushed and the HPU 3 begins unloading gas from compressed gas cylinder 39a of module 59 on the over-the-road semi trailer. The electronic control panel (not visible) sends a signal to actuated shutoff valve 42a on the dispensing port 61 of module 59, and actuated shutoff valve 51 on the HPU 3, opening valves 42a, and 51, allowing the gas in cylinder 39a of module 59 to be dispensed. The gas dispensed from module 59 flows through gas line 54, which has a quick connect/disconnect coupling mechanism positioned at its end, and hose 55 until it reaches gas line 32 of the HPU 3. When the gas reaches line 32 of the HPU 3, the gas flows through shutoff valve 31 and a hydraulic fluid separator 33, and then through a shutoff valve 48, particle filter 46, an actuated shutoff valve 51, and finally through the dispensing gas line 60. As the gas is dispensed (note the gas flow rate is variable) from module 59, the pressure sensor 58 senses the gas pressure drop in cylinder 39a. As the pressure drops, sensor 58 sends an electrical signal to control panel (not visible), which then simultaneously opens actuated shutoff valve 35a on the charging port 62 of module 59 and sends a signal to variable frequency interface 9 of the variable frequency drive 8.

Interface 9 sends a signal to variable frequency controller 12, which then varies the AC frequency to the motor 13. AC motor 13 operates at the commanded AC frequency provided by variable frequency controller 12. This specific frequency corresponds to a specific speed and hydraulic fluid flow rate required to maintain a constant cylinder pressure. Control panel and frequency interface 9 communicate in order to determine the frequency at which motor 13 should operate given the pressure drop in cylinder 39a. Pump 15, operating at a speed dictated by variable frequency motor 29, suctions the hydraulic fluid from tank 6, forcing it through manual shutoff valve 10 and particle filter 11. Pump 15 then forces the hydraulic fluid through the outgoing block 16, outgoing line 26, and outgoing line 57 to incoming oil line 52 of the over-the-road semi trailer. Control valve 3 also acts as an independent safety pressure relief valve, limiting system pressure to 240 bar in case of pressure sensor 58, PLC (not visible), or other system component malfunction. The hydraulic fluid flows through actuated shutoff valve 35a and into cylinder 39a of module 59, forcing the gas from cylinder 39a out the dispensing port 61 of the module. Once pressure sensor 58 senses the gas pressure has reached a desired pressure, such as 220 bar, control panel sends an electronic signal to variable frequency interface 9 and controller 12, which switches off variable frequency motor 13. Alternatively, rather than switching off variable frequency motor 13, the control panel may actuate control valve 17, allowing hydraulic fluid to bypass outgoing line 26 and to reenter the tank 6 through excess-flow valve 3. Check valve 14 prevents oil from flowing back into the tank 6 through line 26 in order to maintain cylinder pressure. During this time, gas is being dispensed through dispensing line 60 and into a vehicle.

It is important to note that there is a minimum speed at which variable frequency drive 8 can operate pump 15. For example, if the flow rate of gas being dispensed from cylinder 39a is zero, or below that minimum value, a maximum pressure will be reached, even at the low speed. As a result, when a maximum pressure is reached, variable frequency motor 13 is switched off, stopping the flow of oil into cylinder 39a. As previously discussed, rather than switching off variable frequency motor 13, the control panel may actuate control valve 17, if needed, allowing hydraulic fluid to bypass outgoing line 26 and to reenter the tank 6 through excess-flow valve 3. Check valve 14 prevents oil from flowing back into the tank 6 through line 26 in order to maintain cylinder pressure.

As illustrated by FIG. 2, variable frequency controller 12 receives a signal from frequency interface 9 in the form of sine wave power 18. Controller 12 then converts the power signal to direct current (DC), before then inverting the power to quasi-sinusoidal AC power 20. The result is variable frequency power that enables control panel and interface 12 to regulate the speed at which motor 13, and subsequently pump 15 operate. The variable speed allows the system to operate efficiently by ensuring that the hydraulic fluid is pumped into cylinder 39a at a proper rate to counter the pressure drop from dispensing gas. Variable frequency drive 8 eliminates the need for flow and control valves to regulate the hydraulic oil pressure. Furthermore, variable frequency drive 8 operates more efficiently than a fixed speed drive as it eliminates any delays in charging associated with the constant cycling that would be required in an absolute system controlled by pressure minimums and maximums. Variable frequency drive 8 reduces any fluctuation in the dispensing pressure of the gas due to the immediate response by drive 8 to the slightest drop in gas pressure. Variable frequency drive 8 allows hydraulic fluid to be pumped into cylinder 39a at a rate equal to that of the gas being dispensing from cylinder 39a, preventing fluctuations in gas pressure.

Gas is simultaneously dispensed and the process discussed above is repeated until the hydraulic fluid volume reaches 95% of the hydraulic volume capacity of cylinder 39a of module 59. When the hydraulic fluid volume reaches 95% of the hydraulic volume capacity of cylinder 39a, level switch 7 of hydraulic fluid tank 6 sends an electronic signal to control panel (not visible), and the control panel (not visible) immediately starts dispensing gas from cylinder 39b and begins unloading hydraulic fluid from cylinder 39a. If cylinder 39b is at the desired pressure, the control panel sends a signal to motor 13, which had been on, and after a short time delay switches off. However, if cylinder 39b is at a pressure less than desired, motor 13 may remain on. Simultaneously, actuated shutoff valves 35a and 42a are closed, and any excess hydraulic oil traveling to cylinder 39a is allowed to flow back to the tank 6 through excess-flow valve 3. At the same time, a signal is sent to actuated shutoff valves 36a and 17, causing them to open.

The residual 5% of the capacity of the hydraulic volume, which is high pressure gas, of cylinder 39a expands, making the hydraulic fluid that had been forced into cylinder 39a of module 59 return to tank 6, flowing through valve 36a and return line 53, hose 56, and the HPU 3 return line 29 to actuated shutoff valve 5 and the oil reservoir tank 6, which is at atmospheric pressure.

When photoelectric sensors 63 and 64 detect gas in return line 29, the sensor sends an electrical signal to the control panel, which sends an electrical signal to actuated shutoff valves 36a and 5, which had been open and now close, thereby shutting down the return of hydraulic fluid to tank 6. In the event that sensors 63, 64, do not detect the presence of gas, a pressure sensor (not visible) within tank 6 monitors the pressure within tank 6. If the pressure in tank 6 were to rise above atmospheric, this would indicate that gas had entered tank 6, and an electric signal would be sent to actuated shutoff valves 36a and 5, closing them.

As previously noted, while the oil discharge process is occurring for cylinder 39a, compressed gas may be simultaneously unloaded from cylinder 39b (beginning another cycle). Additionally, once each cylinder in module 59 is exhausted, a second module with fully charged cylinders located on a second over-the-road semi trailer can connect to the HPU 3 and begin unloading while the hydraulic fluid in final cylinder 39d is discharged. Once the hydraulic oil discharge process begins for cylinder 39d, hoses 57, 54 can be disconnected from module 59 and connected to the second module on the second semi trailer. Compressed gas may then be dispensed from the second module in the same manner as previously discussed, while cylinder 39d is discharging. When the hydraulic oil discharge process for cylinder 39d is complete, hose 56 may be disconnected from module 59 and connected to the second module. Module 59 may then be taken away for refilling of cylinder 39a-d. The number of cylinders in each module, and the number of modules depends solely on the volume of gas that needs to be transported and the manufacturing standards of the over-the-road semi trailer.

The invention has significant advantages. The hydraulic pressurization equipment is capable of servicing motor vehicles efficiently while maintaining the same pressure at all times. The variable frequency drive pumps hydraulic fluid into the cylinders at a rate equal to that of the gas being dispensed, thereby ensure efficient dispensing of the cylinders. The variable frequency drive eliminates large pressure drops that are present in a system based on absolute maximums and minimums. The quick connect/disconnect qualities of the hose connection between the HPU and the cylinder module allow for timely and efficient transition from one module to another.

While the invention has been shown in only a few of its forms, it should be apparent to those skilled in the art that it is not so limited but is susceptible to various changes without departing from the scope of the invention.

1. An apparatus for dispensing compressed gas, the apparatus comprising:
at least one cylinder for containing a quantity of compressed gas;
a gas dispensing port on the cylinder;
a hydraulic fluid port for flowing hydraulic fluid into the cylinder as compressed gas is dispensed;
a hydraulic fluid tank for containing the hydraulic fluid; and
a variable flow rate pump assembly connected between the cylinder and the hydraulic fluid tank for pumping the hydraulic fluid into the cylinder at variable rates to maintain a substantially constant pressure while the compressed gas is dispensed therefrom.

2. The apparatus of claim 1, further comprising:
a transport vehicle; and wherein
the cylinder is mounted on the vehicle.

3. The apparatus of claim 1, wherein the variable flow rate pump assembly comprises:
a variable frequency motor that drives the pump; and
a variable frequency controller for varying a speed of the motor to vary the rate at which hydraulic fluid is pumped into the cylinder.

4. The apparatus of claim 3, wherein the variable flow rate pump assembly further comprises:
a pressure sensor that monitors pressure of the gas in the cylinder; and wherein
a user control interface communicates with the pressure sensor to determine the rate at which hydraulic fluid is pumped into the cylinder and controls the variable frequency controller.

5. The apparatus of claim 1 further comprising:
a discharge line connected between the cylinder and the hydraulic fluid tank, such that the hydraulic fluid is discharged from the cylinder and back into the hydraulic fluid tank when a selected minimum amount of compressed gas in the cylinder remains.

6. The apparatus of claim 1, further comprising:
a pump by-pass connected between the variable flow rate pump assembly and the cylinder for bypassing the hydraulic fluid back into the hydraulic fluid tank when the pressure reaches a desired level when the variable flow rate pump assembly is constantly run.

7. The apparatus of claim 1, wherein the at least one cylinder comprises a plurality of cylinders.

8. The apparatus of claim 1, wherein the variable flow rate pump assembly constantly pumps hydraulic fluid into the cylinder at variable rates while the gas is dispensed.

9. An apparatus for dispensing compressed gas, the apparatus comprising:
a transport vehicle;
at least one cylinder mounted on the vehicle for containing a quantity of compressed gas;
a gas dispensing port on the cylinder;
a hydraulic fluid port on the cylinder for flowing hydraulic fluid into the cylinder as compressed gas is dispensed through the gas dispensing port;
a hydraulic fluid tank for containing the hydraulic fluid;
a pump connected between the cylinder and the hydraulic fluid tank for pumping hydraulic fluid into the cylinder;
a user control interface having a pressure sensor that detects the pressure of the gas in the cylinder;
a variable frequency motor that drives the pump; and
a variable frequency controller for communicating between the user control interface and the variable frequency motor to vary the speed of the motor, and thus the rate at which hydraulic fluid is pumped into the cylinder to maintain a substantially constant pressure in the cylinder while gas is being dispensed therefrom.

10. The apparatus of claim 9, wherein the hydraulic fluid port is located on a charging end of the cylinder and the gas dispensing port if located on a dispensing end of the cylinder.

11. The apparatus of claim 9, further comprising:
a discharge line connected between the cylinder and the hydraulic fluid tank, such that the hydraulic fluid is discharged from the cylinder and back into the hydraulic fluid tank when compressed gas in the cylinder reaches a minimum quantity.

12. The apparatus of claim 9, further comprising:
a pump by-pass connected between the pump and the cylinder for bypassing the hydraulic fluid back into the hydraulic fluid tank when the pressure reaches a desired level when the variable frequency motor is constantly run.

13. The apparatus of claim 9, wherein:
the variable frequency controller stops the variable frequency motor, thereby stopping the pump when the pressure sensor reads a maximum pressure; and
the variable frequency controller starts the variable frequency motor, thereby starting the pump when the pressure sensor reads a minimum pressure.

14. A method of dispensing compressed gas, the method comprising:
(a) mounting at least one compressed gas cylinder on a transport vehicle;
(b) filling the cylinder with compressed gas and moving the transport vehicle to a compressed gas dispensing site;
(c) providing a compressed gas dispensing system with a variable flow rate pump;
(d) dispensing compressed gas from the cylinder; and
(e) pumping hydraulic fluid into the cylinder as the compressed gas is dispensed and varying the rate of hydraulic fluid being pumped to thereby maintain a desired constant pressure in the cylinder.

15. The method of claim 14, wherein step (c) further comprises:
providing the compressed gas dispensing system with a variable frequency controller and a variable frequency motor; and wherein step (e) further comprises:
driving a hydraulic fluid pump with the variable frequency motor and varying the speed of the motor with the variable frequency controller.

16. The method of claim 15, further comprising:
monitoring pressure in the cylinder; and
calculating the speed at which the motor must operate to reach a desired pressure in the cylinder.

17. The method of claim 14, further comprising:
pumping the hydraulic fluid through a by-pass when the cylinder pressure reaches a maximum level, thereby preventing hydraulic fluid from entering the cylinder.

18. The method of claim 15, further comprising:
stopping the variable frequency motor, thereby stopping the pump, when the cylinder pressure reaches a maximum specified level; and
starting the variable frequency motor, thereby starting the pump, when the cylinder pressure reaches a minimum specified level.

19. The method of claim 18, further comprising:
monitoring the pressure in the cylinder with the variable frequency controller.

20. The method of claim 14, further comprising after a selected amount of the compressed gas is dispensed, discharging the hydraulic fluid from the charging end of the at least one cylinder.
